(19) United States
(12) Patent Application Publication
(10) Pub. No.: US 2018/0224222 A1
(43) Pub. Date: Aug. 9, 2018

(54) METHOD FOR PRODUCING A HEAT EXCHANGER AND HEAT EXCHANGER

(71) Applicant: Mahle International GmbH, Stuttgart (DE)

(72) Inventor: Thomas Schiehlen, Altheim (DE)

(21) Appl. No.: 15/749,111

(22) PCT Filed: Aug. 4, 2016
(86) PCT No.: PCT/EP2016/068678

§ 371 Date: Jan. 30, 2018

(30) Foreign Application Priority Data
Aug. 6, 2015 (DE) 10 2015 215 041.0

(51) Int. Cl. F28F 9/16; B21D 39/20

(52) U.S. Cl. CPC F28F 9/162; B21D 39/20; C09J 5/06; F28F 2255/00; F28F 2275/025

(57) ABSTRACT

A method for producing a heat exchanger having tubes, which may be fixed on longitudinal ends in associated openings of a tube plate of a collector, may first include applying an adhesive layer to an outside of each tube by lamination of one of an adhesive layer and an adhesive film. The method may then include inserting each tube with a longitudinal end side tube wall portion into a respective one of the associated openings on the tube plate, wherein the tube wall portion may be bent over in such a manner that it is placed against non-parallel walls of the respective one of the associated openings. The method may further include heating the adhesive layer for adhesive bonding of the tube wall portion of each tube to the non-parallel walls of the respective one of the associated openings.

### CROSS-REFERENCE TO RELATED APPLICATIONS

This application claims priority to International Patent Application No. PCT/EP2016/068678, filed on Aug. 4, 2016, and German Patent Application No. DE 10 2015 215 041.0, filed on Aug. 6, 2015, the contents of both of which are incorporated herein by reference in their entireties.

### TECHNICAL FIELD

The present invention relates to a method for producing a heat exchanger comprising tubes which are fixed on the longitudinal end sides in associated openings of a tube plate of a collector. The invention furthermore relates to such a heat exchanger.

### BACKGROUND

For decades now, cooling modules have been manufactured for use of refrigerant and use of coolant, the cooling modules generally being manufactured with materials which are suitable for brazing, for example stainless steel, copper or aluminum. Said materials as semifinished products are coated with brazing metal. The braze plating of the semifinished products consists of a material layer which has a lower melting point than the basic material. For the brazing, the parts are braced and are subsequently brazed in the furnace at a temperature which reaches close to the melting point of the basic material. Among items needed for this purpose are, for example, fluxing agents which break open or dissolve the oxide layer located on the outside. However, fluxing agents have the disadvantage of being harmful to health; in addition, residues can remain on the components, the residues having a negative effect on the required purity of the component. In addition, the brazing can usefully only connect materials of the same type to one another in order, for example, to absorb thermal elongations or not to allow the latter to arise at all. Similarly, from a corrosion aspect, there should not be any differences in potential between varying materials. The brazing can proceed successfully if various boundary conditions, as follows, are observed: degreasing the parts (currently with PER), stacking and bracing the braze-plated semifinished products, brazing in the furnace at around 650° C. for several hours, checking the tightness of the parts and optionally re-brazing the parts should they not be tight. However, this process is highly time-consuming, costly and resource-intensive, which has a negative effect on the CO2 balance.

During the connection of two joining partners composed of different materials, different thermal expansions have to be taken into consideration and compensated for, which can ensure brazing only to a limited extent or has only a certain creep strength.

Currently, heat exchangers are exclusively brazed, wherein a brazing duration may take several hours, depending on the size of the component. In addition, the brazing temperature lies at approx. 600° C., which means an enormous expenditure of energy over the period of time mentioned. In addition, it can only be seen after hours and a high expenditure of energy whether the brazing has worked.

Such heat exchangers are therefore disadvantageous in that the production thereof is highly costly and resource-intensive and damaging to the environment. Furthermore, only a limited number of materials are suitable for brazing, wherein the components have to be produced from materials of the same type or similar materials in order to achieve reliable brazing. In addition, components composed of different materials cannot be connected to one another at the required quality, if at all.

### SUMMARY

The present invention is therefore concerned with the problem of specifying, for a method for producing a heat exchanger and for such a heat exchanger, an improved or at least a different embodiment which is distinguished in particular by more economical production.

This problem is solved according to the invention by the subject matter of the independent claims. Advantageous embodiments are the subject matter of the dependent claims.

The present invention is based on the general concept of for the first time producing a connection between tubes and a tube plate in a heat exchanger by means of an adhesive connection and of thereby dispensing with a brazed connection which has been used up to now in this region. In the case of the method according to the invention for producing a heat exchanger, an adhesive layer is first of all applied simply in terms of manufacturing and cost-effectively to an outer side of the tubes of the heat exchanger by lamination of an adhesive sheet or an adhesive film, which affords the advantage that said adhesive layer is dry to the touch and does not involve a low-viscosity adhesive system. The tubes are subsequently inserted with a respective longitudinal end side tube wall portion into a respectively associated opening on the tube plate, wherein the tube wall portion of the tube is bent over during or after the insertion in such a manner that said tube wall portion is positioned against non-parallel walls of the associated opening in the tube plate. If this type of form-fitting connection is produced, the adhesive layer is heated, as a result of which the tube wall portions are adhesively bonded to the walls of the respective openings and a fixed assembly between the tubes and the tube plate is thereby produced. The method according to the invention has the great advantage here that brazing metal which so far has been expensive is dispensed with and therefore the method is significantly more cost-effective both in terms of resources and energy. In addition, it is possible in the case of the method according to the invention to apply very thin adhesive layers, and therefore the required quantity of adhesive overall can be kept comparatively low. However, not only is it possible to reduce the duration of the heating, but also the temperature required for curing the adhesive connection, as a result of which a significant saving on energy can also be achieved here. Overall, the method according to the invention is therefore significantly more economical and, furthermore, has the further great advantage that components, here tubes and tube plates, composed of different materials can be connected to one another without there needing to be any concern about galvanic corrosion because of different potentials between the two components. If the need arises, a plastics water box or a metal collector may optionally also be desirably or expediently attached. By means of the possibility of combining different materials, the entire construction of the heat exchanger according to the invention can also be made more flexible. By omitting the brazing process, it is also possible to omit removal of fluxing agent residues which have been present to date. Furthermore, the application of the adhesive layer to the tubes by means of lamination constitutes a cost-effective and at the same time qualitatively high-value manufacturing process. In general, the following further advantages can be realized with the method according to the invention:
increased strength in the region of the adhesive connection,
an adhesive layer which is dry to the touch, not a low-viscosity adhesive system,
with simultaneous flexibility of the adhesive because of its material characteristics,
dissipation of stress concentrations which arise at the connection at different temperature levels and otherwise lead to premature failure of the connection,
omission of a surface pretreatment and therefore of an additional working step required up to now,
the possibility of also at least slightly aligning the tubes and the associated tube plates with one another during and even after the adhesive bonding,
omission of expensive brazing materials,
omission of solvents which have been required up to now for the pretreatment.

In general, all types of heat exchanger, for example Cossacs, evaporators, engine radiators, condensers, charge air coolers, chillers, oil coolers, heating elements, PTC auxiliary heaters, finned heat exchangers, etc., can be produced with the method according to the invention.

The heating of the adhesive layer preferably leads to a change in shape and/or change in structure of the adhesive layer, which permits and/or facilitates connection of the tubes or of the tube plate. Such a change to the adhesive layer is, for example, softening and/or melting and/or expansion and/or hardening of the adhesive layer. The connection between the components by means of the adhesive layer preferably achieves a stable state after the adhesive layer cools following the heating. This is the case in particular whenever the adhesive layer cures.

The connection of the tubes and of the tube plates by means of thermal adhesive bonding furthermore has the advantage that they can be separated from one another when required simply and/or without residues of the adhesive layer. This advantageously takes place by the fact that the adhesive layer is heated again, wherein the adhesive layer is heated in such a manner that the adhesive layer can be separated from at least one of the components. It is thereby in particular possible to dismantle the heat exchanger after expiry of its service life into its individual parts simply and neatly and also according to type and to thereby better recycle said heat exchanger.

The adhesive layer has at least one adhesive means which, for curing, requires a temperature of between 80° C. and 400° C. in order to connect the associated connecting regions. Examples of such adhesive means are Makrofol®, Bayfol®, Kleberit 701.1-701.9 and the like. The adhesive layer advantageously has an adhesive which has thermoplastic properties. That is to say that the adhesive can be deformed above an adhesive-specific temperature which preferably corresponds to the temperature during heating of the adhesive layer in order to connect the components.

The method according to the invention for connecting the tubes to the tube plates furthermore makes it possible to have to heat the adhesive layer only for a relatively short time. In particular, it is possible by means of the method according to the invention to heat the adhesive layer for fewer than 10 minutes. Such a short duration of heating the adhesive layer leads to a reduced consumption of energy, and therefore the heat exchanger can be produced in a cost-effective and environmentally friendly manner. Such short required heating durations are achieved in particular by an appropriate choice of the adhesive layer and/or of the layer thickness of the adhesive layer.

Use is preferably made of adhesive layers which have a relatively small layer thickness. The method according to the invention permits adhesive layers with a layer thickness of 5 μm or less to be used. In particular, use is made of adhesive layers with a layer thickness of between 5 μm and 500 μm.

In order to improve the connection between the components (tubes and tube plates) and/or in order to achieve a desired relative positioning of the components relative to each other, the components are pressed against each other with a contact pressure. It is also conceivable to press the components against one another during and/or after heating of the components. The contact pressure here can be arbitrarily large or small. The limits of the contact pressure are provided here firstly by the fact that the contact pressure is intended to lead to an improved connection of the tube wall portions, which are inserted into the openings of the tube plates, to the walls of the openings, and, secondly, undesirable damage to the components is not intended to be caused. The method is preferably configured in such a manner here that contact pressures of between 0.1 N/mm² and 0.7 N/mm² are used for this purpose.

In preferred variants, the contact pressure is produced by an expanding mandrel which is pushed into the tube, wherein the contact pressure is realized by expansion of the tube. Refinements in which the expanding mandrel is additionally used for heating the adhesive layer are particularly preferred. That is to say that the expanding mandrel can be heated, and therefore upon or during the pushing of the expanding mandrel into the associated tube, the adhesive layer is heated and the contact pressure realized at the same time. As a result, the connection of the components is realized in just a few method steps and as simply and effectively as possible, in particular within a reduced time.

The adhesive layer can also be heated in any other manner. For example, it is possible to heat the adhesive layer in a furnace. The heating of the adhesive layer in a furnace makes it possible in particular to carry out other method steps for producing the heat exchanger in the furnace.

In order to improve the adhesive connection and/or in order to shorten the time required for producing the adhesive connection, the adhesive layer can be cooled after heating. This cooling can be realized in any manner. For example, cooling can be achieved by the fact that the heating of the adhesive layer is time-limited. The cooling can also take place actively by the components being guided or arranged in an environment having a reduced temperature. Specific cooling of the adhesive layer can also take place by the fact that a cooling device is brought into contact with the components or the adhesive layer.

The advantages of the heat exchanger according to the invention and of the production method thereof reside in a simpler and more cost-effective design. By means of this method, as known in general in adhesive bonding, a wide variety of materials having different coefficients of thermal expansion and corrosion potentials can be connected to one another, with at the same time extremely thin layer thicknesses. For the electronic cooling, for example, the processing of copper material as a functional surface for the brazing or sintering of electronic components is required time and again. However, this processing is not possible with current brazing furnaces since impurities due to the processed copper lead to corrosion to the aluminum components. On account of the thin adhesive layer, high thermal conductivity is ensured, which is likewise of great advantage. In addition, the required high tightness, which is generally produced only in the case of welded or brazed components, is also ensured. By means of the adhesive layer/adhesive sheet, the adhesive bond is substantially more cost-effective than, for example, epoxy or silicone adhesive. Application of the adhesive in bead form would require a much higher amount of material than is necessary. This therefore saves material, resources and therefore ultimately costs. Furthermore, the processing of the adhesive is considerably simplified since the processing of the adhesive does not require any machines (pump, nozzle, valve), merely the pressing together of the parts. Furthermore, savings are produced by means of a more rapid and simpler processing of the parts; in particular, curing times in the furnace, of several hours, for the crosslinking are not required. The laminated adhesive layer requires only approx. 3 minutes under a corresponding heated device for the adhesive bonding of the individual parts, said device applying the pressure for the time mentioned.

Further important features and advantages of the invention emerge from the dependent claims, from the drawings and from the associated description of the figures with reference to the drawings.

It goes without saying that the features mentioned above and those which have yet to be explained below are usable not only in the respectively stated combination but also in other combinations or on their own without departing from the scope of the present invention.

Preferred exemplary embodiments of the invention are illustrated in the drawings and are explained in more detail in the description below, wherein the same reference numbers refer to identical or similar or functionally identical components.

### BRIEF DESCRIPTION OF THE DRAWINGS

In the drawings, in each case schematically:

FIG. 1 shows a sectional illustration through a heat exchanger according to the invention in the region of a tube inserted into a tube plate,

FIG. 2 shows an illustration as in FIG. 1, but with a slightly modified embodiment.

### DETAILED DESCRIPTION

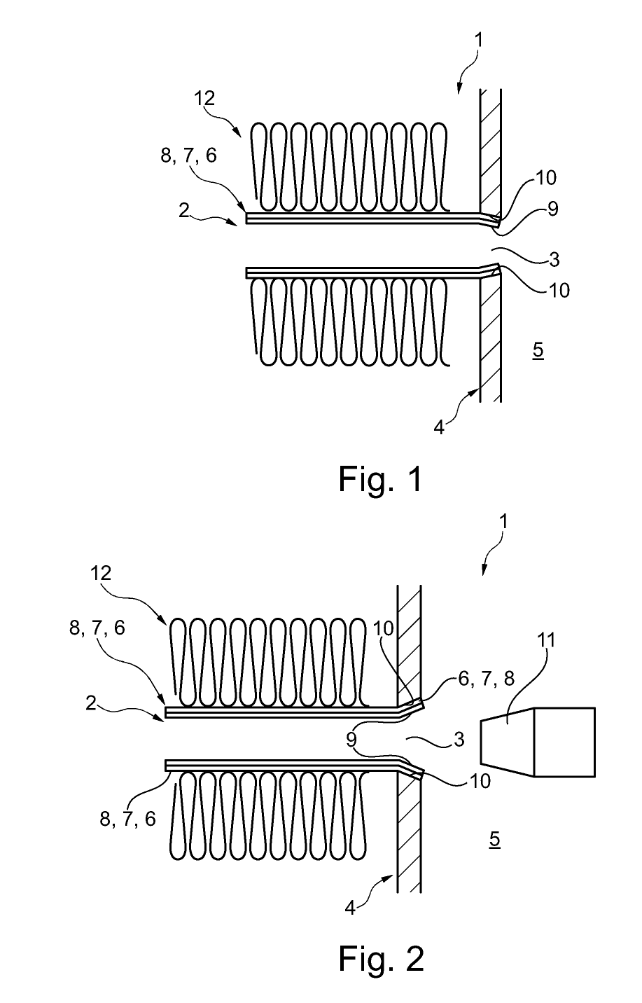

According to FIGS. 1 and 2, a heat exchanger 1 according to the invention has a plurality of tubes 2, of which only a single one is shown in each figure. The tube 2 here is fixed on the longitudinal end side in an associated opening 3 of a tube plate 4 of a collector 5. According to the invention, an adhesive layer 6 is now applied to an outer side of the tube 2 by lamination of an adhesive sheet 7 or of an adhesive film 8. The tube 2 is inserted here with a longitudinal end side tube wall portion 9 in the associated opening 3 on the tube plate 4, wherein the tube wall portion 9 of the tube 2 is bent over in such a manner that said tube wall portion is positioned against non-parallel walls 10 of the associated opening 3. The adhesive layer 6 is heated for adhesive bonding of the tube wall portions 9 to the walls 10 of the openings 3. The openings 3, mentioned here in the plural, result from the fact that only one cutout of the tube plate 4 with a single opening 3 is shown according to FIGS. 1 and 2.

The adhesive layer 6 here has a layer thickness d of between 5 μm and 500 μm and is therefore applied extremely thinly here, as a result of which effective electrical insulation is indeed firstly provided. The electrical insulation is of great advantage here in particular in respect of galvanic corrosion, since it opens up the possibility here of forming the tube 2 or the tubes 2 from a different metal than the tube plate 4. If the material selected for the tube 2 has an entirely different coefficient of thermal expansion than the tube plate 4, the layer thickness d of the adhesive layer 6 can be increased and therefore relative movability can be permitted.

The heat exchanger 1 can be realized in virtually any embodiment, for example as an evaporator, as an engine radiator, as a condenser, as a chiller, as a charge air cooler, as an oil cooler, as a heating element, as a PTC auxiliary heater, as a finned-tube heat exchanger, etc.

The heat exchanger 1 according to the invention is produced by the previously described and mentioned adhesive layer 6 first of all being applied to an outer side of the tubes 2 by lamination of an adhesive sheet 7 or an adhesive film 8. The tubes 2 are subsequently inserted with a longitudinal end side tube wall portion 9 into a respectively associated opening 3 on the tube plate 4, wherein the tube wall portion 9 of the tube 2 is bent over, for example is expanded or bent at right angles, in such a manner that said tube wall portion is positioned against non-parallel walls 10 of the associated opening 3. If this has taken place, the adhesive layer 6 is heated, specifically customarily to a temperature of between 80° C. and 400° C., for adhesively bonding the tube wall portions 9 to the walls 10 of the openings 3.

The adhesive layer 6 is heated here for a comparatively short time, in particular for less than 10 minutes, customarily for merely 2-3 minutes, wherein a significant advantage in respect of a cycle time is possible in comparison to previous brazing. In order to be able to achieve as stable a connection and also adhesive bonding of the tube wall portions 9 to the walls 10 of the openings 3 as possible, the tube wall portions 9 are pressed during the adhesive bonding against the associated walls 10 of the openings 3 with a contact pressure of between 0.1 N/mm² and 0.7 N/mm². Said contact pressure can be produced, for example if the tube wall portion 9 is expanded, by means of an expanding mandrel 11 (cf. FIG. 2) which is pushed into the respective tube 2 or the respective tube wall portion 9 to be expanded. Said expanding mandrel 11 can be equipped with a heating device and can thereby be additionally used for heating the adhesive layer 6. In general, the adhesive layer 6 can, of course, also be heated and therefore activated in a furnace into which the heat exchanger 1 is completely placed.

Looking further at FIGS. 1 and 2, it is possible to see that a fin structure 12, for example corrugated fins, is adhesively bonded to an outer side of the tube 2 via the adhesive layer 6, wherein said fin structure 12 is intended to bring about an increased heat transmission surface and therefore an improved transfer of heat.

In order to be able to further reduce the cycle time for producing the heat exchanger 1 according to the invention, it can also be provided that the adhesive layer 6 is cooled after the adhesive bonding and therefore the curing time is reduced.

With the production method according to the invention and in particular the adhesive layer 6 which is applied according to the invention by lamination, processing of the adhesive can be significantly simplified since machines (pumps, nozzles, valves) which have to be cleaned in a correspondingly complicated manner after the adhesive bonding are no longer required. By means of a comparatively rapid curing time of the adhesive layer 6 of, for example, merely 1-20 minutes, which can advantageously be assisted by, for example, the heatable expanding mandrel 11, the cycle time can also be significantly reduced and, in addition, a high degree of automation achieved. In comparison to brazing, the walls 10 of the openings 3 do not have to be previously degreased by means of PER, as a result of which environmentally hazardous solvents, PER, are no longer required.

With the method according to the invention and the heat exchanger 1 according to the invention, the following advantages can be achieved:
an adhesive layer which is dry to the touch, no low-viscosity adhesive system,
increased strength at the adhesive bond between tube portion 9 and wall 10 of the opening 3, with simultaneous flexibility of the adhesive because of its material characteristics, dissipation of stress concentrations which arise at the connection in the event of different temperature levels and otherwise lead to premature failure of the connection,
omission of a complicated and expensive surface pretreatment,
possible alignment of the tube 2 relative to the tube plate 4 during and even, under some circumstances, after the adhesive bonding,
prevention of galvanic corrosion by the electrically non-conductive adhesive layer 6,
omission of cleaning for eliminating fluxing agent residues,
omission of expensive brazing,
lower outlay on resources by means of very thin adhesive layers 6,
a combination of a wide variety of materials is possible,
bypassing expensive aluminum alloy which have been required up to now for the brazing.

1. A method for producing a heat exchanger having tubes, which are fixed on longitudinal end sides in associated openings of a tube plate of a collector, comprising:
applying an adhesive layer to an outer side of each tube by lamination of one of an adhesive sheet and an adhesive film;
inserting each tubes with a longitudinal end side tube wall portion into a respective one of the associated openings on the tube plate, wherein the tube wall portion is bent over in such a manner that the tube wall portion is placed against non-parallel walls of the respective one of the associated openings; and
heating the adhesive layer for adhesive bonding of the tube wall portion of each tube to the non-parallel walls of the respective one of the associated openings.

2. The method as claimed in claim 1, wherein the adhesive layer is heated to a temperature of between 80° C. and 400° C.

3. The method as claimed in claim 1, wherein the adhesive layer is heated for less than 10 minutes.

4. The method as claimed in claim 1, wherein, during the adhesive bonding, the tube wall portion of each tube is pressed against the non-parallel walls of the respective one of the associated openings with a contact pressure of between 0.1 N/mm² and 0.7 N/mm².

5. The method as claimed in claim 4, wherein at least one of:
the contact pressure is produced by an expanding mandrel being pushed into one of the respective tube or the tube wall portion thereof; and
the tube wall portion of each tube is deformed by the expanding mandrel being pushed into one of the respective tube or the tube wall portion thereof.

6. The method as claimed in claim 5, wherein the expanding mandrel is additionally used for heating the adhesive layer.

7. The method as claimed in claim 1, wherein at least one of:
the adhesive layer is heated in a furnace; and
the adhesive layer is cooled after heating the adhesive layer.

8. The method as claimed in claim 1, wherein the adhesive layer is applied with a layer thickness of between 5 μm and 500 μm.

9. The method as claimed in claim 1, further comprising adhesively bonding a fin structure to an outer side of the tube via the adhesive layer.

10. A heat exchanger comprising tubes each of which is fixed on a longitudinal end side thereof in an associated opening of a tube plate of a collector, said heat exchanger being produced by:
applying an adhesive layer to an outer side of each tube by lamination of one of an adhesive sheet and an adhesive film;
inserting each tube with a longitudinal end side tube wall portion into the associated opening on the tube plate, wherein the tube wall portion is bent over in such a manner that the tube wall portion is placed against non-parallel walls of the associated opening; and
heating the adhesive layer for adhesive bonding of the tube wall portion of each tube to the non-parallel walls of the associated opening.

11. The heat exchanger as claimed in claim 10, wherein the adhesive layer has a layer thickness of between 5 μm and 500 μm.

12. The heat exchanger as claimed in claim 10, wherein the tubes and the tube plate are produced from different materials.

13. The method as claimed in claim 2, wherein the adhesive layer is heated for less than 10 minutes.

14. The method as claimed in claim 2, wherein, during the adhesive bonding, the tube wall portion of each tube is pressed against the non-parallel walls of the respective one of the associated openings with a contact pressure of between 0.1 N/mm² and 0.7 N/mm².

15. The method as claimed in claim 14, wherein at least one of:
the contact pressure is produced by an expanding mandrel being pushed into one of the respective tube or the tube wall portion thereof; and
the tube wall portion of each tube is deformed by the expanding mandrel being pushed into one of the respective tube or the tube wall portion thereof.

16. The method as claimed in claim 15, wherein the expanding mandrel is additionally used for heating the adhesive layer.

17. The method as claimed in claim 2, wherein at least one of:
the adhesive layer is heated in a furnace; and
the adhesive layer is cooled after heating the adhesive layer.

18. The method as claimed in claim 2, wherein the adhesive layer is applied with a layer thickness of between 5 μm and 500 μm.

19. The method as claimed in claim 2, further comprising adhesively bonding a fin structure to an outer side of the tube via the adhesive layer.

20. A method for producing a heat exchanger having tubes, each of which is fixed on a longitudinal end side in an associated opening of a tube plate of a collector, comprising:
applying an adhesive layer to an outer side of each tube by lamination of one of an adhesive sheet and an adhesive film;
inserting each tube with a longitudinal end side tube wall portion into the associated opening on the tube plate, wherein the tube wall portion is bent over in such a manner that the tube wall portion is placed against non-parallel walls of the associated opening; and
heating the adhesive layer for adhesive bonding of the tube wall portion of each tube to the non-parallel walls of the associated opening;
pressing the tube wall portion of each tube against the non-parallel walls of the associated opening during the adhesive bonding with a contact pressure produced by an expanding mandrel being pushed into the tube or tube wall portion; and
deforming the tube wall portion of each tube by the expanding mandrel being pushed into one of the tube or the tube wall portion.
